(19) United States
(12) Patent Application Publication
(10) Pub. No.: US 2019/0205689 A1
(43) Pub. Date: Jul. 4, 2019

(54) METHOD AND DEVICE FOR PROCESSING IMAGE, ELECTRONIC DEVICE AND MEDIUM

(71) Applicant: ZHUHAI JUNTIAN ELECTRONIC TECHNOLOGY CO., LTD., Zhuhai (CN)

(72) Inventor: Chun Jen Huang, Beijing (CN)

(73) Assignee: ZHUHAI JUNTIAN ELECTRONIC TECHNOLOGY CO., LTD., Zhuhai (CN)

(21) Appl. No.: 16/226,800

(22) Filed: Dec. 20, 2018

(30) Foreign Application Priority Data
Dec. 29, 2017 (CN) 201711477933.X

(51) Int. Cl. G06K 9/32; G06K 9/46; G06K 9/00; G06T 7/11; G06T 1/00

(52) U.S. Cl. CPC G06K 9/3241; G06K 9/46; G06T 1/0007; G06T 7/11; G06K 9/00281

(57) ABSTRACT

Embodiments of the present disclosure provide a method and a device for processing an image, an electronic device and a medium. The method includes the followings. A target object contained in the image is identified. The target object is divided into at least one region based on feature points of the target object. A brightness threshold that enables a brightness-darkness distribution ratio of each of the at least one region in conformity with a preset brightness-darkness distribution ratio of a respective region is acquired.

### CROSS REFERENCE TO RELATED APPLICATION

This application is based upon and claims a priority to Chinese Patent Application Serial No. 201711477933.X, filed on Dec. 29, 2017, the entire contents of which are incorporated herein by reference.

### TECHNICAL FIELD

The present disclosure relates to the field of computer, and more particularly, to a method for processing an image, an apparatus for processing an image, an electronic device and a medium.

### BACKGROUND

Nowadays, a variety of personalized picture editing applications enrich user experience, providing users with a lot of creative space, such as picture composition, creative face change, and various filter effects. Among them, in some filter-based applications, a brightness parameter of a filter is usually set for the filter according to brightness of a current picture or brightness of ambient lights of a capturing environment.

### SUMMARY

Embodiments of the present disclosure provide a method for processing an image. The method includes:

identifying a target object contained in the image;

dividing the target object into at least one region based on feature points of the target object; and

acquiring a brightness threshold that enables a ratio of a bright region to a dark region of each of the at least one region in conformity with a preset brightness-darkness distribution ratio of a respective region, in which the brightness threshold is configured to determine the bright region and the dark region.

Embodiments of the present disclosure provide a device for processing an image. The device includes:

an identifying unit, configured to identify a target object contained in the image;

a dividing unit, configured to divide the target object into at least one region based on feature points of the target object; and

an acquiring unit, configured to acquire a brightness threshold that enables ratio of a bright region to a dark region of each of the at least one region in conformity with a preset brightness-darkness distribution ratio of a respective region, in which the brightness threshold is configured to determine the bright region and the dark region.

Embodiments of the present disclosure provide an electronic device. The electronic device includes a processor and a memory, connected to the processor; in which the memory is configured to store computer programs, the computer programs comprise program instructions; and the processor is configured to invoke the program instructions to execute the method according to embodiments of the first aspect of the present disclosure.

### BRIEF DESCRIPTION OF THE DRAWINGS

In order to further clearer describe technical solutions of embodiments of the present disclosure or in related arts, simply descriptions will be made to drawings necessitated by describing embodiments of the present disclosure or by the related arts. Obviously, the drawings described below are merely some embodiments of the present disclosure, and other drawings may be obtained by those skilled in the art without any inventive labors according to these drawings.

FIG. 1 is a flow chart illustrating a method for processing an image provided in embodiments of the present disclosure;

FIG. 2 a flow chart illustrating another method for processing an image provided in embodiments of the present disclosure;

FIG. 3 is a block diagram illustrating a device for processing an image provided in embodiments of the present disclosure; and

FIG. 4 is a schematic diagram illustrating an electronic device provided in embodiments of the present disclosure.

### DETAILED DESCRIPTION

Clear and complete descriptions will be made to technical solutions of embodiments of the present disclosure with reference to drawings of embodiments of the present disclosure. Obviously, the described embodiments are merely parts of embodiments instead of all embodiments of the present disclosure. Based on the embodiments illustrated in the present disclosure, other embodiments obtained by those skilled in the art without any inventive labor are all covered by the scope of the present disclosure.

A picture may be subjected to filter processing according to a brightness parameter. Such a filter processing will result in a good filter effect of some parts of the picture, and a poor filter effect of some parts of the picture, and even an object contained in the picture filtered cannot be seen clearly.

Applicants have found that, due to different environmental light rays for capturing different images, under a fixed brightness parameter of a filter, it may be not ensured that all images have best filtering effects using the filter. For example, under a certain filter, when a brightness threshold parameter is set as 100, for an image captured under environmental light rays with suitable brightness, the image may be divided into a bright region and a dark region according to the brightness threshold. Further, the bright region is subjected to a different filtering dyeing processing from that subjected by the dark region, to obtain a respective better filter effect. However, for an image captured under environmental light rays with dark light rays, the whole image may be divided into the dark region according to the brightness threshold. Further, when the image is subjected to the filtering dyeing processing, the filter effect may be poor.

Embodiments of the present disclosure provide a method for processing an image, a device for processing an image, an electronic device and a medium, which may solve a problem of a poor effect of filtering an image when the image is captured under dark environmental light rays.

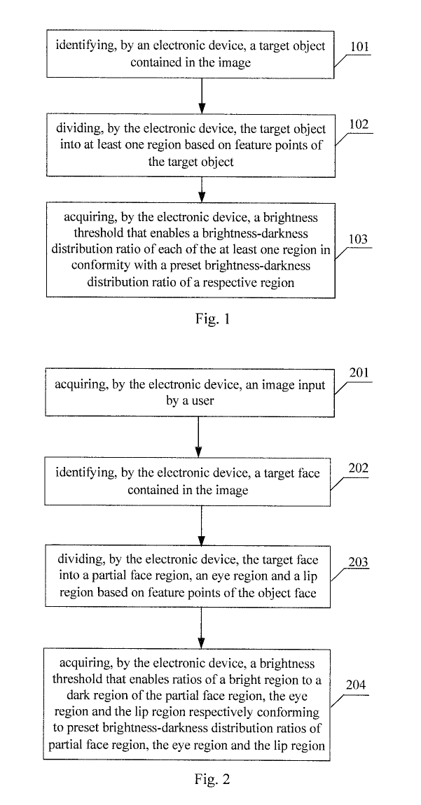

Referring to FIG. 1, FIG. 1 is a flow chart illustrating a method for processing an image provided in embodiments of the present disclosure. The method illustrated as FIG. 1 may include the followings.

At block 101, a target object contained in an image is identified by an electronic device.

The electronic device may be a portable electronic device, such as a phone, a tablet computer or the like, or may be a non-portable electronic device, such as a laptop or the like. The image may be input by a user, or may be captured in real time via a built-in software having a capturing capacity invoked by the electronic device. The target object refers to a main body to which the electronic device set a brightness threshold, for example the target object may be a face or a subject like a cup, a building and so on. The target object identified by the electronic device may be one or may be plurality. In detail, the electronic device may acquire a plurality of objects contained in the image that is input by the user or captured by a camera. For example, one image input by the user is acquired. The image contains a face, a tree, the sky or the like. The electronic device needs to use a related technology to identify the target object contained in the image. In this example, it may be assumed that the main body to which the electronic device desires to set a brightness threshold is the face. The face contained in the image may be identified using a face recognition technology. That is, the target object contained in the image identified by the electronic device is the face. It may also be assumed that the main body to which the electronic device desires to set the brightness threshold is the tree. The tree contained in the image may be identified using a related technology and may be determined as the target object. Details of the related technology are not limited herein.

Alternatively, when at least two objects are contained in the image, identifying the target object contained in the image includes the following. A ratio of an area occupied by each object to an area of the image are computed respectively for the at least two objects contained in the image. It is determined whether the ratio of each object conforms to a preset ratio. An object having the ratio in conformity with the preset ratio is determined as the target object.

At block 102, the target object is divided into at least one region by the electronic device according to feature points of the target object.

Alternatively, the target object acquired by the electronic device may include a plurality of feature points. In some image editing software or other applications, a processing way is changed with the feature point. Therefore, the electronic device needs to divide the target object into a plurality of different regions according to the feature points of the target object, such that the target object may be hierarchically processed to acquire a better effect. For example, it may be assumed that the target object identified by the electronic device is the face. The face includes some sections such as eyes, nose, lips and the like, and the feature points of these sections are different. When the face is subjected to the filter, the processing ways to different sections of the face are different. For example, it desires to enlarge the eyes, and heighten the nose. When the face is considered as a whole region to be filtered, a filtered effect obtained may be not good. Therefore, it needs to divide the face into the plurality of regions by the electronic device according to the feature points of different sections of the face, such that different filtering processes are performed on different sections so as to obtain a better image editing effect.

Alternatively, when the target object is the face, dividing the target object into at least one region according to the feature points of the target object includes the followings. Information of the feature points of the face is obtained using the face recognition technology. Facial features of the face are constructed according to the information of the feature points of the face. The face is divided into a partial face region, an eye region, and a lip region according to the facial features. The feature points of the face refer to feature points of eyes, eyebrows, nose and lips. The electronic device may extract the above feature points using a face template including the above organs. Alternatively, the electronic device may extract the above feature points using other technologies.

At block 103, the electronic device acquires a brightness threshold that enables a ratio of a bright region to a dark region of each of the at least one region in conformity with a preset brightness-darkness distribution ratio for a respective region.

The preset brightness-darkness distribution ratio for each of the at least one region may be set in advance by the electronic device, or may be defaulted by an image editing software or other applications of the electronic device. The brightness threshold is configured to determine the bright region and the dark region for each region. In other words, the brightness threshold is configured as a standard to measure the bright region and the dark region. It may be assumed that for each region, a region having a brightness value less than the brightness threshold is determined as the dark region, while a region having a brightness value greater than the brightness threshold is determined as the bright region.

In detail, the electronic device acquires the brightness threshold enabling the ratio of the bright region to the dark region for each of the at least one region in conformity with the preset brightness-darkness distribution ratio for the respective region. That is, the electric device determines a brightness threshold as a brightness division standard for determining the bright region and the dark region of each of the at least one region. In addition, it may be ensured that when the brightness threshold is determined as the brightness division standard, the ratio of the bright region to the dark region for each of the at least one region conforms to the preset brightness-darkness distribution ratio of the respective region.

Alternatively, acquiring, by the electronic device, the brightness threshold enabling the ratio of the bright region to the dark region for each of the at least one region in conformity with the preset brightness-darkness distribution ratio of the respective region includes the followings. Each brightness value within a preset brightness value range is determined as a threshold respectively to compute the brightness-darkness distribution ratio for each of the least one region. It is determined whether the brightness-darkness distribution ratio computed for each of the at least one region equals to the preset brightness-darkness distribution ratio of the respective region. A current brightness value is determined as a brightness threshold acquired. That is to say, the method for acquiring the brightness threshold by the electronic device may include the followings. Each brightness value included in the preset brightness value range is determined as the threshold and the brightness-darkness distribution ratio of each of the at least one region is computed to compare to the preset brightness-darkness distribution ratio of the respective region. If the brightness-darkness distribution ratio of each of the at least one region conforms to the preset brightness-darkness distribution ratio of the respective region, the current brightness value is determined as the brightness threshold; otherwise, the current brightness value is added by a preset value via the electronic device or the current brightness value is subtracted by a preset value via the electronic device, and the above processes are executed again, until a brightness value acquired by the electronic device enables the brightness-darkness distribution ratio of each of the at least one region in conformity with the preset brightness-darkness distribution ratio of the respective region. In addition, the brightness value acquired by the electronic device is determined as the brightness value.

Alternatively, determining, by the electronic device, each brightness value within the preset brightness value range as the threshold respectively to compute the brightness-darkness distribution ratio of each of the at least one region includes the followings. For each of the at least one region, a brightness array is determined according to a color array of the respective region. Under each brightness value within the preset brightness value range determined as the threshold, each of the at least one region is divided into the bright region and the dark region according to the brightness array of the respective region. Further, a distribution ratio of the bright region to the dark region of the respective region is computed respectively. That is to say, when each brightness value included in the preset brightness value range is determined by the electronic device as the threshold, the method for computing the brightness-darkness distribution ratio for each of the at least one region may include the followings. A brightness value within the preset brightness value range is determined by the electronic device as the threshold, and the color array of each of the at least one region is converted to the brightness array to facilitate determination of the bright region and the dark region for the respective region and acquisition of the brightness value of the respective region. The electronic device may determine each brightness value included in the preset brightness value range as the threshold, divide each of the at least one region into the bright region and the dark region according to the brightness array of the respective region, and compute respectively a percentage of an area occupied by the dark region and a percentage of an area occupied by the brightness region in the respective region.

In embodiments, after the target object contained in the image is identified by the electronic device, the target object is divided into at least one region according to the feature points of the target object. The brightness threshold enabling the ratio of the bright region to the dark region of each of the at least one region in conformity with the preset brightness-darkness distribution ratio of the respective region is acquired. The brightness threshold is configured to determine the bright region and the dark region for each of the at least one region. It solves how to set a suitable brightness threshold for the bright region and the dark region obtained by dividing an image captured under different ambient light conditions, thereby improving a processing effect of the filter.

Referring to FIG. 2, FIG. 2 illustrates another method for processing an image provided in embodiments of the present disclosure. The method illustrated as FIG. 2 includes the followings.

At block 201, an image input by a user is acquired by an electronic device.

At block 202, a target face contained in the image is identified by the electronic device.

The image acquired by the electronic device may be a photo loaded by the electronic device which is selected by the user from a photo set, or may be a photo captured in real time by invoking phone software having a capturing capacity via the electronic device according to the user's demands. For example, it may be assumed that the electronic device is a phone. The phone may acquire a photo selected by the user from the photo set of the phone as the image. Alternatively, the phone may acquire a photo captured by the phone software having the capturing capacity as the image. In embodiments, how to acquire by the electronic device the image input by the user is not limited herein.

The electronic device identifies the target face contained in the acquired image. Alternatively, the electronic may identifies the target face contained in the acquired image using a face recognition technology. In other words, the electronic device may identify whether the target face is contained in the image input by the user using the face recognition technology. In detail, the electronic device may determine whether it is able to acquire information of feature points of the target face from the image using the face recognition technology. When it is able to acquire the information of feature points of the target face, it is indicated that the target face is contained in the image. When it is unable to acquire the information of feature points of the target face, it is indicated that the target face is not contained in the image. The method for processing an image described in embodiments of the present disclosure is to set different brightness thresholds for different faces, such that better display effects of the different faces may be obtained under different filters. Therefore, in embodiments of the present disclosure, when the electronic device identifies that the target image is contained in the image, a block 203 is executed, while when the electronic device identifies that the target image is not contained in the image, the block 203 is not executed, thereby saving power consumption of the electronic device.

At block 203, the target face is divided, by the electronic device, into a partial face region, an eye region and a lip region based on the feature points of the target face.

In detail, when the electronic device identifies that the target face is contained in the acquired image, the target face may be divided into the partial face region, the eye region and the lip region according to the feature points of the target face. Alternatively, the information of the feature points of the target face may be obtained by the electronic device using the face recognition technology. Alternatively, the electronic device may acquire the information of the feature points of the target face using the face recognition technology. The electronic device constructs facial features of the target face based on the information of the feature points, and divides the target face into the partial face region, the eye region and the lip region based on the facial features. For example, it is assumed that the electronic device identifies that the image input by the user contains the target face, and it is assumed that the electronic device obtains the feature points of the target face using the face recognition technology. Five organs of the target face such as ears, nose, eyes, lips and eyebrows may be constructed based on the feature points. The electronic device may preset a division rule of the target face in advance, for example the division rule of the target face preset by the electronic device may be that the nose, the ears and the eyebrows are divided into one region referred as the partial face region, the eyes are divided into a single region referred as the eye region, and the lips are divided into a single region referred as the lip region. In this example, the electronic device may divide the target face into the partial face region, the eye region and the lip region according to the facial features.

Alternatively, when it is identified that at least two objects are contained in the image input by the user, identifying the target object contained in the image includes the followings. Ratios of areas occupied by the at least two objects contained in the image to an area of the image are computed respectively. It is determined whether the ratios conform to a preset ratio. The object having the ratio in conformity with the preset ratio is determined as the target object. In other words, when the electronic device identifies that at least two faces are contained in the image input by the user, it may be determined which face is the target face desired to be identified by the electronic device by computing the ratio of the area occupied by each of the at least two faces to the area of the image. For example, after the image input by the user is acquired by the electronic device, it may be identified that two faces are contained in the image using the face recognition technology, and it is assumed that a preset ratio of the area occupied by the target face to the area of the image is 50% by the electronic device. That is, when the ratio of the area occupied by a face contained in the image to the area of the image acquired by the electronic device is greater than or equal to 50%, it may be determined that the face is the target face. The electronic device may acquire the area occupied by each of the two faces contained in the image using the face recognition technology, and may compute the ration of the area occupied by each of the two faces to the area of the image respectively. It may be assumed that a ratio of the area occupied by a first face to the area of the whole image is 60%, while the ratio of the area of a second face to the area of the whole image is 20%. The electronic device may determine that the ratio of the first face conforms to the preset ratio of the area occupied by the target object to the area of the whole image after comparison. Therefore, the electronic device identifies the first face as the target face.

Alternatively, the target face contained in the image identified by the electronic device may be plurality. For example, the electronic device may preset the preset ratio of the area occupied by the target face to the area of the image, for example the preset ratio may be 30%. It is assumed that the electronic device identifies that three faces are contained in the image, and the ratios of the areas occupied by the three faces to the area of the image includes the followings. A first ratio of the area occupied by the first face to the area of the image is 40%, a second ratio of the area occupied by the second face to the area of the image is 35% and a third ratio of the area occupied by the third face to the area of the image is 10%. The electronic device may determine that the first ratio of the first face and the second ratio of the second are both greater than 30% after comparison. Therefore, the electronic device may identify that the first face and the second face are both the target face.

At block 204, the electronic device acquires the brightness threshold that enables the ratios of the bright region to the dark region for the partial face region, the eye region and the lip region in conformity with preset brightness-darkness distribution ratios of the partial face region, the eye region and the lip region respectively.

Alternatively, the electronic device may preset the preset brightness-darkness distribution ratios for the partial face region, the eye region and the lip region. In other words, when the ratio of the bright region to the dark region of each section equals to the preset brightness-darkness distribution ratio of the respective section, a better effect of editing the above sections may be got. For example, with a certain filter, when the ratio of the bright region to the dark region of the partial face region conforms to the preset brightness-darkness distribution ratio of the partial face region, a better filtering effect of the partial face region under the current filter may be obtained.

Alternatively, acquiring, by the electronic device, the brightness threshold enabling the ratios of the bright region to the dark region of the partial face region, the eye region and the lip region respectively in conformity with the preset brightness-darkness distribution ratios of the partial face region, the eye region and the lip region includes the following. Each brightness value within a preset brightness value range is determined as a threshold to respectively compute the brightness-darkness distribution ratio for the partial face region, the eye region and the lip region. It is determined whether the brightness-darkness distribution ratio of each region conforms to the preset brightness-darkness distribution ratio of the respective region. The brightness value that enables the brightness-darkness distribution ratios of the partial face region, the eye region and the lip region are all in conformity with the preset brightness-darkness distribution ratios is determined as the brightness threshold. Alternatively, computing the brightness-darkness distribution ratios of the partial face region, the eye region and the lip region by determining each brightness value included in the preset brightness value range as the threshold includes the followings. For the partial face region, the eye region and the lip region, a brightness array is determined according to a color array of the partial face region, the eye region and the lip region. Under each brightness value included in the preset brightness value range determined as the threshold, each of the partial face region, the eye region and the lip region is divided into the bright region and the dark region according to the brightness array of the partial face region, the eye region and the lip region. The distribution ratio of the bright region to the dark region is computed for each of the above regions.

In other words, after the target face is divided by the electronic device into the partial face region, the eye region and the lip region, the color arrays of the three regions are converted into the brightness arrays so as to acquire brightness of each region. Then each brightness value included in the present brightness value range is determined as a current threshold, and the brightness-darkness distribution ratios of the three regions under the current threshold are computed according to the brightness arrays of the three regions. The electronic device detects whether each of the brightness-darkness distribution ratios of the partial face region, the eye region and the lip region is in conformity of the preset brightness-darkness distribution ratio of the respective region. If conformity, the current threshold is determined as the acquired brightness threshold; otherwise, the current brightness is added or subtracted by a predetermined value, and the above processes are repeated unit the electronic device acquires the brightness threshold.

For example, it may be assumed that the electronic device acquires the photo input by the user, and two faces are contained in the photo. The ratios of the areas occupied by the first face and the second face to the area of the photo may be computed respectively. It is determined whether the computed ratios are in conformity with a preset ratio of an area occupied by the target face to the area of the image, so as to obtain the face having the ratio in conformity with the above preset ratio as the target face identified by the electronic device. It is assumed that one target face is obtained through the above processes. The feature points of the target face may be obtained using the face recognition technology. The target face may be divided into the partial face region, the eye region and the lip region according to the feature points of the target face and a division rule preset by the electronic device. It may be assumed that the division rule is to divide eyes into a single region, to divide lips into a single region, and to divide other of the target face into a single region referred as the partial face region. The electronic device may preset the brightness-darkness distribution ratios of each region in advance such that the proportion of the bright region in the partial face region is 74% while the proportion of the dark region in the partial face region is 26%; the proportion of the bright region in the eye region is 60% while the proportion of the dark region in the eye region is 40%; and the proportion of the bright region in the lip region is 55% while the proportion of the dark region in the lip region is 45%.

The electronic device selects a suitable brightness threshold for the target face described in the above example. In detail, the electronic device determines each brightness value included in a preset brightness value range as a threshold in turn to compute the brightness-darkness distribution ratios for the partial face region, the eye region and the lip region respectively under the current threshold. The computed brightness-darkness distribution ratios of the three regions are respectively compared to a respective preset brightness-darkness distribution ratio of each of the three regions. When the computed brightness-darkness distribution ratios are all in conformity with the respective preset brightness-darkness distribution ratio, the electronic device determines the current brightness as the brightness threshold. In other words, the brightness value range is preset by the electronic device in advance, for example 0-255. Each brightness value included in the brightness value range is sequentially determined by the electronic device from minimum to maximum or from maximum to minimum as the threshold. It may be assumed that a brightness value 1 included in the preset brightness value range is determined as the threshold to compute the brightness-darkness distribution ratios of the partial face region, the eye region and the lip region respectively under the threshold. When the brightness-darkness distribution ratios of the three regions are all in conformity with the preset brightness-darkness distribution ratios of the three regions respectively, the electronic device determines the current brightness value 1 as the brightness threshold. On the contrary, the electronic device adds the brightness value 1 by 1 or by a preset value to obtain a new threshold, and the above processes are repeated, until a threshold set by the electronic device may enable the brightness-darkness distribution ratios of the partial face region, the eye region and the lip region in conformity with the respective preset brightness-darkness distribution ratio. It is assumed that the above processes are executed repeatedly by the electronic device until the brightness value is 110. At that brightness value, the brightness-darkness distribution rations of the partial face region, the eye region and the lip region are both in conformity with the respective preset brightness-darkness distribution ratio. Therefore, the brightness value 110 is determined as the brightness threshold of the target face.

The electronic device according to embodiments of the present disclosure may identify the target face contained in the image input by the user. The target face is divided by the electronic device into the partial face region, the eye region and the lip region according to the feature points of the target face. The electronic device acquires the brightness threshold for the target face. The brightness threshold is a brightness enabling the ratios of the bright region to the dark region of the partial face region, the eye region and the lip region all respectively in conformity with the preset brightness-darkness distribution ratio of the partial face region, the eye region and the lip region. It may solve how to set a suitable brightness threshold for the bright region and the dark region obtained by dividing an image containing the target face and captured under different ambient light conditions, thereby improving a processing effect of the filter.

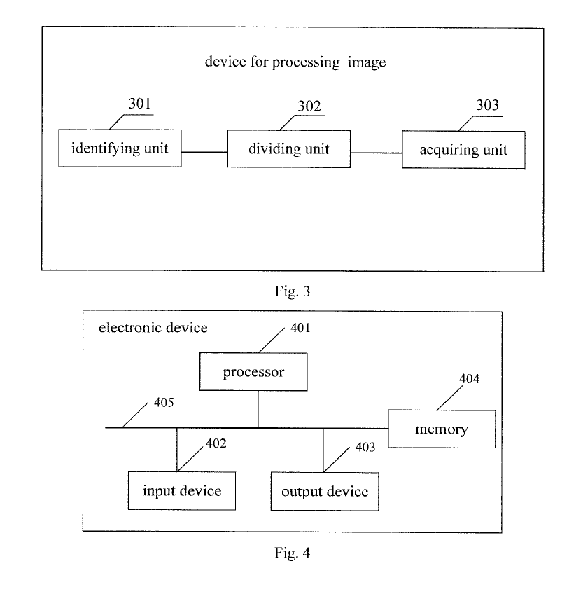

Referring to FIG. 3, FIG. 3 is a block diagram illustrating a device for processing an image provided in embodiments of the present disclosure. The device illustrated as FIG. 3 may include an identifying unit 301, a dividing unit 302 and an acquiring unit 303.

The identifying unit 301 is configured to identify a target object obtained in an image.

The dividing unit 302 is configured to divide the target object into at least one region according to feature points of the target object.

The acquiring unit 303 is configured to acquire a brightness threshold that enables a ratio of a bright region to a dark region of each of the at least one region in conformity with a preset brightness-darkness distribution ratio of a respective region. The brightness threshold is configured to determine the bright region and the dark region.

In other words, the brightness threshold acquired by the acquiring unit 303 is configured to determine the bright area and the dark area for each of the at least one region of the target object. The brightness threshold is to ensure that the brightness-darkness distribution ratio of each region conforms to a respective preset brightness-darkness distribution ratio. Therefore, it may guarantee that each region of the target object contained in the image has a better effect in an image editing software or in other image editing software, such as a filter, thereby ensuring that the electronic device may obtain a better filtering effect of the target object.

Alternatively, when the target object contained in the image identified by the identifying unit 301 is a target face, the dividing unit 302 is configured to obtain information of feature points of the face using a face recognition technology. In addition, the dividing unit 302 is configured to construct facial features of the face according to the information of feature points so as to divide the face into a partial face region, an eye region and a lip region according to the facial features.

Alternatively, the acquiring unit 303 is configured to determine each brightness value included in a preset brightness value range as a threshold to respectively compute the brightness-darkness distribution ratio of each of the at least one region. In addition, the acquiring unit 303 is further configured to determine whether the brightness-darkness distribution ratio of each of the at least one region conforms to a preset brightness-darkness distribution ratio of the respective region. Furthermore, the acquiring unit 303 is further configured to acquire a brightness that enables the brightness-darkness distribution ratio of each of the at least one region in conformity with the preset brightness-darkness distribution ratio of the respective region as the brightness threshold.

Alternatively, determining each brightness included in the preset brightness value range as the threshold to respectively compute the brightness-darkness distribution ratio of each of the at least one region includes the followings. For each of the at least one region, a brightness array of the each of the at least one region is determined based on a color array of the respective region. Under each brightness value within the preset brightness value range determined as the threshold, each of the at least one region is divided respectively into the bright region and the dark region according to the brightness array of respective region. A distribution ratio of the bright region to the dark region is computed for each of the at least one region.

Alternatively, when at least two objects are contained in the image, the identifying unit 301 is configured to compute respectively a ratio of an area occupied by each of the at least two objects to an area of the image. In addition, the identifying unit 301 is further configured to determine whether the computed ratio conforms to a preset ratio. Furthermore, the identifying unit 301 is configured to determine an object having the ratio in conformity of the preset ratio as the target object.

In embodiments, the identifying unit 301 is configured to identify the target object contained in the image. The dividing unit 302 is configured to divide the target object into at least one region according to the feature points of the target object. The acquiring unit 303 is configured to acquire the brightness threshold that enables the ratio of the bright region to the dark region of each of the at least one region in conformity with the preset brightness-darkness distribution ration of the respective region. The brightness threshold is configured to determine the bright region and the dark region for each of the at least one region. It may solve how to set a suitable brightness threshold for the bright region and the dark region obtained by dividing an image captured under different ambient light conditions, thereby improving a processing effect of the filter.

It may be understood that, functions of various functional modules, units of the device for processing an image provided in embodiments may be specifically implemented according to the method described in above method embodiments. And particular implementation processes may be referred to related descriptions made to the above method embodiments, which are not elaborated herein.

Referring to FIG. 4, FIG. 4 is a schematic diagram illustrating an electronic device provided in embodiments of the present disclosure. The electronic device of embodiments illustrated as FIG. 4 includes one or more processors 401, one or more input devices 402, one or more output devices 403 and a memory 404. The above processor 401, the input device 402, the output device 403 and the memory 404 are connected to each other via a bus 405. The memory 404 is configured to store computer programs. The computer programs include program instructions. The processor 401 is configured to execute the program instructions stored in the memory 404. The processor 401 is configured to execute the followings by running the program instructions.

A target object contained in the image is identified.

The target object is divided into at least one region based on feature points of the target object.

A brightness threshold that enables a ratio of a bright region to a dark region of each of the at least one region in conformity with a preset brightness-darkness distribution ratio of a respective region is acquired. The brightness threshold is configured to determine the bright region and the dark region.

Alternatively, when the target object is a face, the processor 401 is configured to execute the followings by running the program instructions, so as to realize dividing the target object into the at least one region based on the feature points of the target object.

Information of the feature points of the face is obtained using a face recognition technology.

Facial features of the face are constructed based on the information of the feature points of the face, and the face is divided into a partial face region, an eye region and a lip region based on the facial features.

Alternatively, the processor 401 is configured to execute the followings by running the program instructions, so as to realize obtaining the brightness threshold that enables the ratio of the bright region to the dark region of each of the at least one region in conformity with the preset brightness-darkness distribution ratio of the respective region.

Each brightness value within a preset brightness value range is determined as a threshold respectively to compute the brightness-darkness distribution ratio of each of the at least one region.

It is determined whether the brightness-darkness distribution ratio of each of the at least one region conforms to the preset brightness-darkness distribution ratio of the respective region.

The brightness value that enables the brightness-darkness distribution ratio of each of the at least one region in conformity with the preset brightness-darkness distribution ratio of the respective region is determined as the brightness value obtained.

Alternatively, the processor 401 is configured to execute the followings by running the program instructions, so as to realize determining each brightness value within the preset brightness value range as the threshold respectively to compute the brightness-darkness distribution ration of each of the at least one region.

For each of the at least one region, a brightness array of each of the at least one region is determined based on a color array of the respective region.

For each brightness value within the preset brightness value range determined as the threshold, each of the at least one region is divided into the bright region and the dark region according to the brightness array of the respective region. A distribution ratio of the bright region to the dark region is computed for each of the at least one region.

Alternatively, the processor 401 is configured to execute the followings by running the program instructions, so as to realize identifying the target object contained in the image when at least two objects are contained in the image.

A ratio of an area occupied by each of the at least two objects to an area of the image is computed respectively.

It is determined whether the ratio conforms to a preset ratio.

An object having the ratio in conformity with the preset ratio is determined as the target object.

In should be understood that, in embodiments of the present disclosure, the so-called processor 401 may be a central processing unit (CPU). The processor may also be other general-purpose processor, digital signal processor (DSP), application specific integrated circuit (ASIC), field-programmable gate array (FPGA) or other programmable logical components, discrete gate or transistor logic devices, discrete hardware components, and the like. The general-purpose processor may be a micro-processor or the processor may be any commonly used processor.

The input device 402 may be a touch panel, a fingerprint collecting sensor (configured to collect information of the fingerprint of the user or information of directions of the fingerprint), a microphone or the like. the output device 403 may include a display (LCD or the like), a microphone or the like.

The memory 404 may include a read-only memory and a random access memory, and provide the processor 501 with instructions and data. A portion of memory 404 may also include a non-volatile random access memory. For example, memory 404 may also store information of device types.

In practical implementation, the processor 401, the input device 402, the output device 403 described in embodiments of the present disclosure may execute embodiments of the image for processing an image provided in FIG. 1 of the present disclosure and implementations described in embodiments of the device for image processing provided in FIG. 2, or the implementations of the electronic device described in embodiments as FIG. 3 of the present disclosure, and details are not described herein again.

Embodiments of the present disclosure provide a medium. The medium stores computer programs. The computer programs include program instructions. The program instructions are executed by a processor, to execute the followings.

A target object contained in the image is identified.

The target object is divided into at least one region based on feature points of the target object.

A brightness threshold that enables a ratio of a bright region to a dark region of each of the at least one region in conformity with a preset brightness-darkness distribution ratio of a respective region is acquired. The brightness threshold is configured to determine the bright region and the dark region.

Alternatively, when the target object is a face, the program instructions are executed by the processor to execute the followings, so as to realize dividing the target object into the at least one region based on the feature points of the target object.

Information of the feature points of the face is obtained using a face recognition technology.

Facial features of the face are constructed based on the information of the feature points of the face, and the face is divided into a partial face region, an eye region and a lip region based on the facial features.

Alternatively, the program instructions are executed by the processor to execute the followings, so as to realize obtaining the brightness threshold that enables the ratio of the bright region to the dark region of each of the at least one region in conformity with the preset brightness-darkness distribution ratio of the respective region.

Each brightness value within a preset brightness value range is determined as a threshold respectively to compute the brightness-darkness distribution ratio of each of the at least one region.

It is determined whether the brightness-darkness distribution ratio of each of the at least one region conforms to the preset brightness-darkness distribution ratio of the respective region.

The brightness value that enables the brightness-darkness distribution ratio of each of the at least one region in conformity with the preset brightness-darkness distribution ratio of the respective region is determined as the brightness value obtained.

Alternatively, the program instructions are executed by the processor to execute the followings, so as to realize determining each brightness value within the preset brightness value range as the threshold respectively to compute the brightness-darkness distribution ration of each of the at least one region.

For each of the at least one region, a brightness array of each of the at least one region is determined based on a color array of the respective region.

For each brightness value within the preset brightness value range determined as the threshold, each of the at least one region is divided into the bright region and the dark region according to the brightness array of the respective region. A distribution ratio of the bright region to the dark region is computed for each of the at least one region.

Alternatively, the program instructions are executed by the processor to execute the followings, so as to realize identifying the target object contained in the image when at least two objects are contained in the image.

A ratio of an area occupied by each of the at least two objects to an area of the image is computed respectively.

It is determined whether the ratio conforms to a preset ratio.

An object having the ratio in conformity with the preset ratio is determined as the target object.

Embodiments of the present disclosure provide an application, including program instructions. When the program instructions are executed, followings are executed.

A target object contained in the image is identified.

The target object is divided into at least one region based on feature points of the target object.

A brightness threshold that enables a ratio of a bright region to a dark region of each of the at least one region in conformity with a preset brightness-darkness distribution ratio of a respective region is acquired. The brightness threshold is configured to determine the bright region and the dark region.

Alternatively, when the target object is a face, the program instructions are executed to execute the followings, so as to realize dividing the target object into the at least one region based on the feature points of the target object.

Information of the feature points of the face is obtained using a face recognition technology.

Facial features of the face are constructed based on the information of the feature points of the face, and the face is divided into a partial face region, an eye region and a lip region based on the facial features.

Alternatively, the program instructions are executed to execute the followings, so as to realize obtaining the brightness threshold that enables the ratio of the bright region to the dark region of each of the at least one region in conformity with the preset brightness-darkness distribution ratio of the respective region.

Each brightness value within a preset brightness value range is determined as a threshold respectively to compute the brightness-darkness distribution ratio of each of the at least one region.

It is determined whether the brightness-darkness distribution ratio of each of the at least one region conforms to the preset brightness-darkness distribution ratio of the respective region.

The brightness value that enables the brightness-darkness distribution ratio of each of the at least one region in conformity with the preset brightness-darkness distribution ratio of the respective region is determined as the brightness value obtained.

Alternatively, the program instructions are executed to execute the followings, so as to realize determining each brightness value within the preset brightness value range as the threshold respectively to compute the brightness-darkness distribution ration of each of the at least one region.

For each of the at least one region, a brightness array of each of the at least one region is determined based on a color array of the respective region.

For each brightness value within the preset brightness value range determined as the threshold, each of the at least one region is divided into the bright region and the dark region according to the brightness array of the respective region. A distribution ratio of the bright region to the dark region is computed for each of the at least one region.

Alternatively, the program instructions are executed to execute the followings, so as to realize identifying the target object contained in the image when at least two objects are contained in the image.

A ratio of an area occupied by each of the at least two objects to an area of the image is computed respectively.

It is determined whether the ratio conforms to a preset ratio.

An object having the ratio in conformity with the preset ratio is determined as the target object.

Those skilled in the art may understand that, all or part of the processes in implementing the method of above embodiments can be realized via related hardware instructed by computer programs, and the programs can be stored in a computer readable storage medium. When the programs are executed, flows of embodiments of each method described above may be included. The storage medium may be a magnetic disk, an optical disk, a read-only memory (ROM), a random access memory (RAM) or the like.

Descriptions described above are merely preferred embodiments of the present disclosure, and may not be construed to limit the scope of the present disclosure. Those skilled in the art can understand that all or parts of processes for implementing foregoing embodiments as well as equivalents made according to claims of the present disclosure are still within the scope of the present disclosure.

What is claimed is:

1. A method for processing an image, comprising:
identifying a target object contained in the image;
dividing the target object into at least one region based on feature points of the target object; and
acquiring a brightness threshold that enables a brightness-darkness distribution ratio of each of the at least one region in conformity with a preset brightness-darkness distribution ratio of a respective region, wherein the brightness-darkness distribution ration is configured as a ratio of an area occupied by a bright region to an area occupied by a dark region, and the brightness threshold is configured to determine the bright region and the dark region.

2. The method according to claim 1, wherein when the target object is a face, dividing the target object into the at least one region based on the feature points of the target object comprises:
obtaining information of the feature points of the face using a face recognition technology; and
constructing facial features of the face based on the information of the feature points of the face, and dividing the face into a partial face region, an eye region and a lip region based on the facial features.

3. The method according to claim 1, wherein obtaining the brightness threshold that enables the brightness-darkness distribution ratio of each of the at least one region in conformity with the preset brightness-darkness distribution ratio of the respective region comprises:
determining each brightness value within a preset brightness value range as a threshold respectively to compute the brightness-darkness distribution ratio of each of the at least one region;
determining whether the brightness-darkness distribution ratio of each of the at least one region conforms to the preset brightness-darkness distribution ratio of the respective region; and
determining the brightness value that enables the brightness-darkness distribution ratio of each of the at least one region in conformity with the preset brightness-darkness distribution ratio of the respective region as the brightness value obtained.

4. The method according to claim 3, wherein determining each brightness value within the preset brightness value range as the threshold respectively to compute the brightness-darkness distribution ration of each of the at least one region comprises:
for each of the at least one region, determining a brightness array of each of the at least one region based on a color array of the respective region; and
for each brightness value within the preset brightness value range determined as the threshold, dividing each of the at least one region into the bright region and the dark region according to the brightness array of each of the at least one region, and computing a the brightness-darkness distribution ratio for each of the at least one region.

5. The method according to claim 1, wherein when at least two objects are contained in the image, identifying the target object contained in the image comprises:
computing respectively a ratio of an area occupied by each of the at least two objects to an area of the image;
determining whether the ratio conforms to a preset ratio; and
determining an object having the ratio in conformity with the preset ratio as the target object.

6. A device for processing an image, comprising:
an identifying unit, configured to identify a target object contained in the image;
a dividing unit, configured to divide the target object into at least one region based on feature points of the target object; and
an acquiring unit, configured to acquire a brightness threshold that enables a brightness-darkness distribution ratio of each of the at least one region in conformity with a preset brightness-darkness distribution ratio of a respective region, wherein the brightness-darkness distribution ration is configured as a ratio of an area occupied by a bright region to an area occupied by a dark region, and the brightness threshold is configured to determine the bright region and the dark region.

7. The device according to claim 6, wherein, when the target object is a face, the dividing unit is further configured to:
obtain information of the feature points of the face using a face recognition technology; and
construct facial features of the face based on the information of the feature points of the face, and dividing the face into a partial face region, an eye region and a lip region based on the facial features.

8. The device according to claim 6, wherein the acquiring unit is further configured to:
determine each brightness value within a preset brightness value range as a threshold respectively to compute the brightness-darkness distribution ratio of each of the at least one region;
determine whether the brightness-darkness distribution ratio of each of the at least one region conforms to the preset brightness-darkness distribution ratio of the respective region; and
determine the brightness value that enables the brightness-darkness distribution ratio of each of the at least one region in conformity with the preset brightness-darkness distribution ratio of the respective region as the brightness value obtained.

9. The device according to claim 8, wherein determining each brightness value within the preset brightness value range as the threshold respectively to compute the brightness-darkness distribution ration of each of the at least one region comprises:
for each of the at least one region, determining a brightness array of each of the at least one region based on a color array of the respective region; and
for each brightness value within the preset brightness value range determined as the threshold, dividing each of the at least one region into the bright region and the dark region according to the brightness array of each of the at least one region, and computing the brightness-darkness distribution ratio for each of the at least one region.

10. The device according to claim 6, wherein when at least two objects are contained in the image, the identifying unit is further configured to:
compute respectively a ratio of an area occupied by each of the at least two objects to an area of the image;
determine whether the ratio conforms to a preset ratio; and
determine an object having the ratio in conformity with the preset ratio as the target object.

11. An electronic device, comprising:
a processor and
a memory, connected to the processor,
wherein the memory is configured to store computer programs, the computer programs comprise program instructions; and the processor is configured to run the program instructions to execute:
identify a target object contained in the image;
divide the target object into at least one region based on feature points of the target object; and
acquire a brightness threshold that enables a brightness-darkness distribution ratio of each of the at least one region in conformity with a preset brightness-darkness distribution ratio of a respective region, wherein the brightness-darkness distribution ration is configured as a ratio of an area occupied by a bright region to an area occupied by a dark region, and the brightness threshold is configured to determine the bright region and the dark region.

12. The electronic device according to claim 11, wherein, when the target object is a face, the processor is further configured to execute the followings so as to realize dividing the target object into the at least one region based on the feature points of the target object:
obtaining information of the feature points of the face using a face recognition technology; and
constructing facial features of the face based on the information of the feature points of the face, and dividing the face into a partial face region, an eye region and a lip region based on the facial features.

13. The electronic device according to claim 11, wherein the processor is further configured to execute the followings so as to realize obtaining the brightness threshold that enables the brightness-darkness distribution ratio of each of the at least one region in conformity with the preset brightness-darkness distribution ratio of the respective region:
determining each brightness value within a preset brightness value range as a threshold respectively to compute the brightness-darkness distribution ratio of each of the at least one region;
determining whether the brightness-darkness distribution ratio of each of the at least one region conforms to the preset brightness-darkness distribution ratio of the respective region; and
determining the brightness value that enables the brightness-darkness distribution ratio of each of the at least one region in conformity with the preset brightness-darkness distribution ratio of the respective region as the brightness value obtained.

14. The electronic device according to claim 13, wherein the processor is further configured to execute the followings so as to realize determining each brightness value within the preset brightness value range as the threshold respectively to compute the brightness-darkness distribution ration of each of the at least one region:
for each of the at least one region, determining a brightness array of each of the at least one region based on a color array of the respective region; and
for each brightness value within the preset brightness value range determined as the threshold, dividing each of the at least one region into the bright region and the dark region according to the brightness array of each of the at least one region, and computing a the brightness-darkness distribution ratio for each of the at least one region.

15. The electronic device according to claim 11, wherein, when at least two objects are contained in the image, the processor is further configured to execute the followings so as to realize identifying the target object contained in the image:
computing respectively a ratio of an area occupied by each of the at least two objects to an area of the image;
determining whether the ratio conforms to a preset ratio; and
determining an object having the ratio in conformity with the preset ratio as the target object.
